(19) United States
(12) Patent Application Publication
(10) Pub. No.: US 2005/0265918 A1
(43) Pub. Date: Dec. 1, 2005

(54) Method for manufacturing nanometer scale crystal titanium dioxide photo-catalyst sol-gel

(76) Inventor: Wen-Chuan Liu, Taipei (TW)

Correspondence Address: WEN-CHUAN LIU, 235 Chung-Ho, Box 8-24, Taipei, TW

(21) Appl. No.: 10/857,728

(22) Filed: Jun. 1, 2004

(51) Int. Cl. C01G 23/047

(52) U.S. Cl. 423/610

(57) ABSTRACT

A method for manufacturing nanometer scale crystal titanium dioxide photo-catalyst sol-gel is disclosed. Titanium compound is dissolved and diluted in a predetermined acid liquid to form titanium diluted solution, and the pH value is adjusted to be between 7.0 to 9.0. Then titanium hydroxide in the solution is filtered so as to get filter cake and then it is cleaned. Then oxidant and inorganic acid is added to form titanium dioxide sol-gel solution under predetermined conditions. The titanium dioxide sol-gel solution can be transparent or yellow color depending on operation conditions. The content of photo-catalyst is between 0.5 to 10%.

### FIELD OF THE INVENTION

The present invention relates to photo-catalysts, and particular to a method for manufacturing nanometer scale crystal titanium dioxide photo-catalyst sol-gel. The titanium dioxide sol-gel made from the present invention is applied on home electric devices, illuminations, air cleaning, kitchen devices, cleaning walls, sanitary utensils, furniture, car decorations, and processing of waste water, gas, etc. In the present invention, chemical processing is used to synthesize nanometer scale titanium dioxide sol-gel solution with a particle size between 2 to 50 nm and the content of titanium dioxide is from 0.5 to 1.0%.

### BACKGROUND OF THE INVENTION

From 1970s, a large amount of documents disclosed methods for manufacturing semiconductor titanium dioxide. Most of the documents use normal chemical components, especially titanium dioxide particles, as raw material. The photochemical reaction and semiconductor reaction are also discussed. The configuration of crystals and size of the particles will affect the efficiency of the reactions.

Based on the disclosed documents, to synthesize titanium dioxide photo-catalyst, most of the prior arts uses chemical synthesis to make titanium dioxide particles. Although in many cases, the grinding method is used to make titanium dioxides (such as P-25 grinding method used by Degussa Co.). However, this method cannot make titanium dioxide particles with uniform particle size (from 10 to 500 nm) and the crystal configurations are not matched to required ones. Thereby, it is used in painting, cosmetic, correction fluid, etc. Effect of photo-catalyst cannot be presented. Although the grinding process is modified, supersonic grinding with supersonic oscillation or chemical grinding with acid liquid is adopted for improving the size and uniformity of titanium dioxide particles, but the effects of these improvements are finite. They cannot greatly improve the configurations of crystals. Thereby, the applications of the products are also confined.

For the chemical synthesis, liquid synthesis is the main method. In the prior art, chemical vapor deposition (CVD) method is used to grow titanium dioxide photo-catalyst film, which can provide high stability, high purity photo-catalyst, but manufacturing cost is high and only suitable for some specific products. This prior art cannot be used for mass-production.

Liquid synthesis is classified into two methods, organic solvent method and aqueous method. The aqueous method is a preferred one making titanium dioxide photo-catalysts.

The organic solvent method uses Ti-alkyloxide:Ti(OR)4 in different solvents so as to form titanium dioxide powder or film depending on the heating process. One of these prior arts is disclosed in Japanese Patent No. 4-83537, in that, titanium alkyl- oxide is heated in ethylene glycol. In Japanese Patent No. 7-10037, titanium alkyl-oxide is heated in amino-alcohol so as to get titanium dioxide. Since the titanium alkyl-oxide is expensive and the operation must be performed in high temperature and high pressure. Thereby, the products by these ways are generally used in industrial chemical catalyst instead of civil purpose. The aqueous synthesis are mostly disclosed in Japanese patents or Japanese related documents, such as Japanese Patent No. 7-171408, the binding agent is added to the titanium tetrachloride and heated. In Japanese Patent No. 6-293519, under the condition of pH≦3, water solution of titanium tetrachloride solution is directly heated so as to form titanium dioxide sol-gel. The defect of this method is that a large amount of chloride ions retained so that the sol-gel is unstable and easy to. precipitate. In Japanese Patent No. 9-71418, hydrogen peroxide solution is added to titanium hydroxide, and the pH is 6 to 8 and temperature is lower. In Japanese Patent No. 62-252319, hydrogen peroxide solution is added to titanium hydroxide, and the reaction condition of pH value is 2 to 6, temperature is low and reaction time is longer. The titanium dioxide sol-gel generated by these ways with particle size about 10 nanometers. Since the particles are mainly non-crystal, it can be used in surface treatment, but it is not an effective photo-catalyst. In Japanese Patent No. 7-28614, pertitanic acid is heated and in Japanese Patent No. 285993, hydrogen peroxide solution is added to titanium hydroxide and then reaction temperature is increased so as to form titanium dioxide sol-gel. The products have photo-catalytic effect. Due to the property of hydrogen peroxide, the concentration of the titanium dioxide sol-gel is confined to be below 2%. Thereby, it cannot be widely used.

In Taiwan Patent No. 135895, titanium tetrachloride solution is added with organic acid. Then the solution is heated at temperature above 70° C. so as to form anatase titanium dioxide. The titanium dioxide sol-gel produced by this way is matched to the requirements of configurations of crystal and size of particles, but the content of chloride is high (above 10 grams/liter). Thereby, the stability of the product is not preferred.

In Taiwan Patent No. 349981, the titanium tetrachloride reacts with ammonia water with a pH value of 2 to 6. Then the precipitate (titanium hydroxide or titanic acid) is filtered and rinsed. Hydrogen peroxide is added into the solution in low temperature (5 to 8° C.). The solution is agitated for a longer time so as to disperse non-crystal titanium dioxide which is unrelated to the present invention. In Taiwan Patent No. 393342, the titanium sulfate is heated to form titanium dioxide and then mono-proton acid (such as nitric acid, etc.) is added to the titanium dioxide for removing residue sulfate ions and solving titanium dioxide to reduce the particle size of the titanium dioxide. This prior art is also unrelated to the present invention. Taiwan Patent No. 443992 discloses a method for forming titanium dioxide film instead of sol-gel.

In France Patent No. 2551743, alkaline earth metal-titanium dioxide is formed, but it is unrelated to the present invention.

### SUMMARY OF THE INVENTION

The present invention provides a method for manufacturing nanometer scale crystal titanium dioxide photo-catalyst sol-gel, comprising the steps of:
Dissolving and diluting titanium compound in a predetermined acid liquid to form titanium diluted solution,
Performing a neutralization process, namely, adding ammonia water with a predetermined concentration into the titanium diluted solution under a predetermined filling speed so as to adjust pH value to be between 5 to 9;
Executing a cleaning process; namely, filtering the titanium hydroxide in the solution so as to get filter cake and cleaning the titanium hydroxide;
Executing a form-transfer process; namely, mixing the titanium hydroxide into pure water (de-ionized water) and agitate the titanium hydroxide solution so that the titanium hydroxide is uniformly mixed in the de-ionized water; then adding predetermined oxidant or inorganic acid;
Forming the mixing solution in predetermined temperature and time so as to get sol-gel; and
Adjusting the pH value of the sol-gel; and filtering and packing the sol-gel as a product.

The present invention improves the defects of water solution synthesis method (for example, high chloride concentration, low stability, and unmatched crystal configuration, etc.). Thereby, the present invention provides a method of manufacturing process to synthesize nanometer scale titanium dioxide photo-catalyst sol-gel. The process includes dilution process, neutralization process, form-transfer process, formation process and packaging process.

In the dilution process, the acid liquid for dilution is selected from diluted hydrochloric acid (used for titanium tetrachloride) and diluted sulfuric acid (used for titanium sulfate). A concentration of the acidic liquid is about 0 to 4M (mole/liter). The diluted titanium compound has a concentration of between 5 and 10 wt/L %. The agitating speed is between 30 to 600 rpm the dilution temperature is between 4 to 30° C.; and the reaction time in dilution is between one to four hours.

In the neutralization process, the concentration of the ammonia water (ammonium hydroxide) is 10 to 25%; the filling speed of the ammonia water is 1 to 30 ml/min depending on pH value of the solution. In the neutralization process, an agitation operation is executed, and the agitation speed is between 120 to 1200 rpm with a reaction time between one to four hours and reaction temperature lower then 20° C.; and the addition of ammonia water is ended at the pH value being equal to 5 to 9. In the neutralization process, the titanium compound in the water solution will react to get titanic acid or titanium hydroxide and the titanic acid or titanium hydroxide is filtered out to get white powder. The titanic acid or titanium hydroxide is filtered to form filter cake which is then placed in running water or soft water to be agitated so to uniformly disperse through a predetermined time. The running water used must be at least five times, of the filter cake. The agitation, filtering and cleaning steps are performed at least three times. A dewaterer, a compressing filter, a vacuum filter or a centrifuge are used in as the filter in the filtering operation.

The filter cake is placed in de-ionized water to be agitated and thus to be mixed uniformly; and then selected oxidant or inorganic acid is added for the form-transfer process. The oxidant is selected from at least one of perchloric acid, periodide acid, potassium permanganate, sodium permanganate, and nitric acid; and 1 to 200 grams/liters oxidant is used; the inorganic acid is selected from at least one of perchloric acid, periodide acid, nitric acid, phosphoric acid, hydrochloric acid, sulfuric acid, and hydrogen iodide, hydrobromic acid. 1 to 200 ml/liters of inorganic acid is added. The form-transfer temperature is between 10 to 95° C. and the agitation speed in form transfer is between 30 to 300 rpm through 10 to 120 minutes.

At least one of the oxidant and inorganic acid is added, which is determined as desired. If the product can be directly sprayed or coating to a surface, the oxidant is preferable. If the product is made as film or to be further finished or to have a high concentration, the inorganic acid or the two are used. The selection of inorganic alkali is based on the application of the product and environments. The titanic acid with oxidant or inorganic acid is performed with form transfer reaction according to a set of temperature and time period. In the present invention, the form-transfer temperature is between 10 and 95° C. (depending on additive objects) through a time period of at least 10 minutes and the agitation speed is retained on 30 to 300 rpm.

The titanium dioxide sol-gel is heated to 50 to 95° C. for executing formation reaction. The sol-gel is filtered and packaged as products.

### BRIEF DESCRIPTION OF THE DRAWINGS

FIG. 1 is a block diagram about the method for forming the Titanium Dioxide (TiO2) photo-catalyst Sol-Gel Solution according to the present invention.

FIG. 2 is a block diagram of the manufacturing process of the present invention.

### DETAILED DESCRIPTION OF THE INVENTION

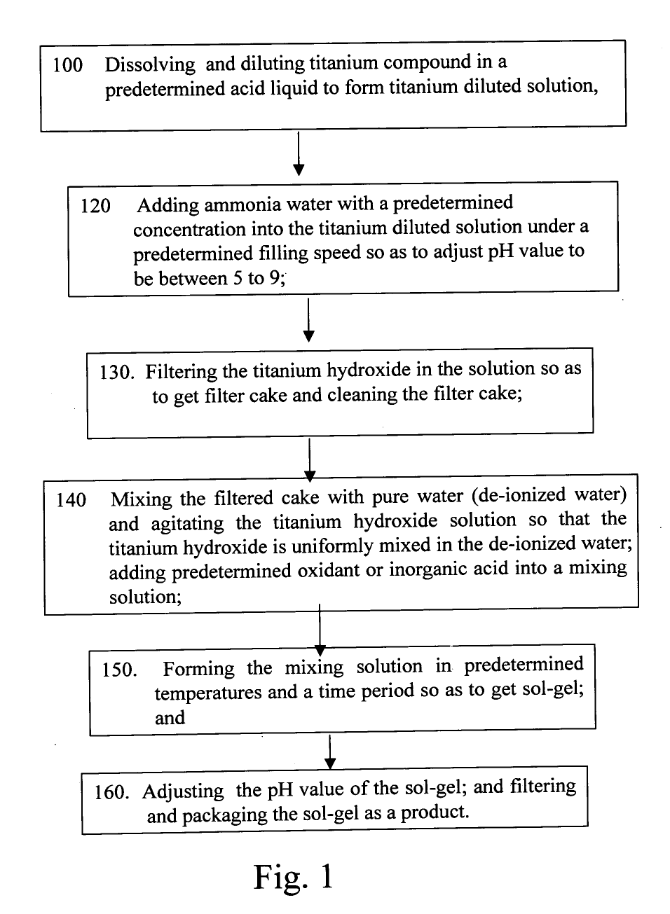

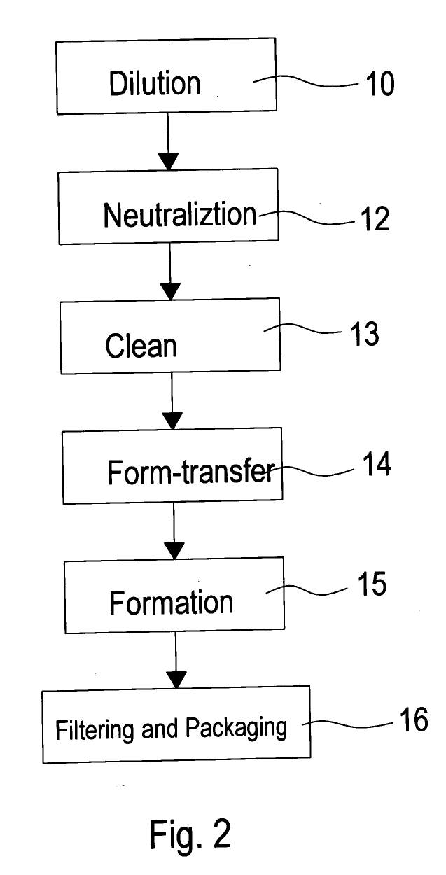

In order that those skills in the art can further understand the present invention, a description will be described in the following in details. However, these descriptions and the appended drawings are only used to cause those skills in the art to understand the objects, features, and characteristics of the present invention, not to be used to confine the scope and spirit of the present invention defined in the appended claims. Referring to FIG. 1, the method for preparation of the anatase titanium dioxide (TiO₂) photo-catalyst according to the present invention is illustrated. In the present invention. The method of the present invention comprises the steps of:
Dissolving and diluting titanium compound in a predetermined acid liquid to form titanium diluted solution (step 10 in FIG. 2 and step 100 in FIG. 1);
Performing a neutralization process, namely, adding ammonia water with a predetermined concentration into the titanium diluted solution under a predetermined filling speed so as to adjust pH value to be between 5 to 9 (step 12 in FIG. 2 and step 120 in FIG. 1);
Executing a cleaning process; namely, filtering the titanium hydroxide in the solution so as to get filter cake and cleaning the titanium hydroxide (step 13 in FIG. 2 and step 130 in FIG. 1);
Executing a form-transfer process; namely, mixing the titanium hydroxide into pure water (de-ionized water) and agitate the titanium hydroxide solution so that the titanium hydroxide is uniformly mixed in the de-ionized water; and adding predetermined oxidant or inorganic acid into a mixing solution (step 14 in FIG. 2 and step 140 in FIG. 1);
Forming the mixing solution in predetermined temperature and time period so as to get sol-gel (step 15 in FIG. 2 and step 150 in FIG. 1); and
Adjusting the pH value of the sol-gel; then filtering and packing the sol-gel as a product (step 10 in FIG. 2 and step 100 in FIG. 1).

In the following, a plurality of embodiments about the method of the present invention will be illustrated so that those skills in the art can understand the present invention.

### First Embodiment

10 liters de-ionized water are added to a reaction tank with a volume of 20 liters. The agitating speed is set at 300 rpm. The reaction tank is retained in temperature of 5 to 10° C. by ice-water bath. A predetermined amount, 500 grams, of titanium tetrachloride (with a ratio of 98%) is added to the water with a speed of 4 ml/min by using a dosing pump. When all the titanium tetrachloride is added and agitated through 2 hours until the liquid is clear and become transparent, ammonia water with a concentration of 20% is added with an addition speed of 10 ml/min and an agitation speed of 600 rpm. Variation of pH value is monitored. When the pH value is attained to 4.0, the addition speed is changed to 2-4 ml/min until the pH value is achieved to 7.5 to 8.0. Above solution is filtered in a vacuum filter. Then filter cake (containing titanium hydroxide) from the solution is added to a clean tank of 200 liters. The tank has been filled with running water or soft water of 100 liters. The agitation speed is set at 600 rpm and the agitation time period is 2 hours until the filter cake are uniformly mixed in the water. Then it is filtered. The process of cleaning and filtering are repeated three times. Then the filter cake is transferred to a form-transfer and formation tanks. 20 liters de-ionized water is added to the tank. The agitation speed is retained at 300 rpm. The filter cake is added and then the solution is agitated through one hour so that they are mixed uniformly. Then 50 ml of perchloric acid (HClO4) is added to the solution. In constant, the solution is agitated through 80 min. The temperature of solution is increased to 80 to 90° C. The solution is agitated through 6 hours. The temperature of the solution is decreased and pH is adjusted. Then the solution is packaged as product. In the present invention, the acquired titanium dioxide sol-gel is colorless or yellow transparent water solution with a pH value of about 5 to 9. The content of titanium dioxide is about 1% and the size of the particle is about 5 to 50 nm, which is presented as needle-like or sheet-like crystal. The present invention can be directly used in spray treatment or is processed as film so as to have the function of self-cleaning. If the solution of the present invention is radiated by ultra-violet light, it has the function of sterilization.

### Second Embodiment

The process is the same as the first embodiment. In the form-transfer process, 75 grams of the potassium permanganate (KMnO4) is used to replace perchloric acid (HClO₄). Operation conditions are same as the first embodiment. The acquired titanium dioxide sol-gel is yellow transparent solution with a pH value between 7 and 9. The content of titanium dioxide is 1%. The particle size is about 5 to 30 nm with needle-like or sheet-like crystals. The titanium dioxide of this embodiment contains Mn which has function of cleaning and sterilization. Since the content of potassium is very few, it is suitable in industry.

### Third Embodiment

The process is the same as the first embodiment except that the content of titanium tetrachloride is changed to 2.5 liters. The perchloric acid (HClO₄) for form-transfer process is changed to 150 ml. Other conditions are identical to the first embodiment. The processed titanium dioxide (TiO₂) particles are the same as those in the first embodiment, but the content of the titanium dioxide in the sol-gel is about 5%. In the product of this embodiment, the content of photo-catalyst is high. Other than the functions of mildew-proof, cleaning, and sterilization, the titanium dioxide photo-catalyst of this embodiment can be used in cleaning wall or sanitation.

### Fourth Embodiment

9 liters de-ionized water are added to a reaction tank with a volume of 20 liters. The agitating speed is set at 600 rpm. Then one liter of sulfuric acid is filled into the solution. Then 400 grams of titanium oxysulfate (TiOSO₄) is added into the agitated diluted sulfuric acid oxysulfate. The solution is agitated continuously until the titanium sulfuric acid is dissolved completely (through at least 2 hours). Then 20% ammonia water is added to the solution with a speed of 10 ml/min. Other steps are identical to those of first embodiment; and the product of this embodiment is the same as that of the first embodiment.

### Fifth Embodiment

The process is same as the first embodiment, but in the acidification process, phosphoric acid (H₃PO₄) is used to replace perchloric acid. The amount of phosphoric acid is about 100 to 150 ml. The formation temperature is increased to 90 to 95° C. with a time period of 8 to 12 hours. Then Titanium Dioxide (TiO₂)photo-catalyst Sol-Gel Solution is acquired. The Titanium Dioxide (TiO₂) photo-catalyst Sol-Gel Solution is colorless or white. The contents and components are same as the first embodiment, but because less sulfate ion is added to the solution. Thereby, this embodiment can achieve the effect of cleaning and adhesion effectively.

### Sixth Embodiment

The processing steps and operation conditions are identical to those in the first embodiment, but the formation temperature is 70 to 80° C. and the reaction time is prolonged to 24 hours. The Titanium dioxide (TiO₂) photo-catalyst Sol-Gel Solution acquired in this embodiment has the same components and functions as the first embodiment.

### Seventh Embodiment

The processing steps and operation conditions are identical to those in the first embodiment, but the perchloric acid of 10 ml is used in the form-transfer. Moreover, phosphoric acid of 50 ml is further added. Other operations are identical to those in the first embodiment. The formation temperature is increased to 90 to 95° C. The reaction time is 6 hours. The Titanium Dioxide (TiO2) photo-catalyst Sol-Gel Solution acquired in this embodiment has the same components and functions as the fifth embodiment.

### Eighth Embodiment

The processing steps and operation conditions are identical to those in the second embodiment, but the potassium permanganate added is 80 grams and further phosphoric acid of 150 ml is added. The formation temperature is increased to 90 to 95 degrees, and the reaction time is 8 hours. The Titanium Dioxide (TiO2) photo-catalyst Sol-Gel Solution acquired in this embodiment has the same components and functions as the second embodiment.

Advantages of the present invention will be described herein. The present invention has the function of self-cleaning. Moreover, the present invention has the effect of sterilization with the radiation of ultra-violet. Furthermore, the present invention has the functions of cleanness and adhesion.

The present invention is thus described, it will be obvious that the same may be varied in many ways. Such variations are not to be regarded as a departure from the spirit and scope of the present invention, and all such modifications as would be obvious to one skills in the art are intended to be included within the scope of the following claims.

1. A method for manufacturing nanometer scale crystal titanium dioxide photo-catalyst sol-gel, comprising the steps of:
dissolving and diluting titanium compound in a predetermined acid liquid to form titanium diluted solution,
performing a neutralization process, namely, adding ammonia water with a predetermined concentration into the titanium diluted solution under a predetermined filling speed so as to adjust pH value to be between 5 to 9;
executing a cleaning process; namely, filtering the titanium hydroxide in the solution so as to get filter cakes and cleaning the filter cakes;
executing a form-transfer process; namely, mixing the filtered cakes with pure water (de-ionized water) and agitating the titanium hydroxide solution so that the titanium hydroxide is uniformly mixed in the de-ionized water; adding predetermined oxidant or inorganic acid into a mixing solution;
forming the mixing solution in predetermined temperatures and a time period so as to get sol-gel; and
adjusting a pH value of the sol-gel; then filtering and packaging the sol-gel as a product.

2. The method as claimed in claim 1, wherein the titanium compound is selected from one of titanium tetrachloride (TiCl4) and titanium oxysulfate (TiO(SO4)).

3. The method as claimed in claim 1, wherein the acid liquid for dilution is selected from diluted hydrochloric acid (used for titanium tetrachloride) and diluted sulfuric acid (used in titanium oxysulfate); a concentration of the acidic liquid is about 0 to 4M (mole/liter); the diluted titanium compound has a concentration of between 5 and 10 wt %; the agitating speed is between 30 and 600 rpm, the temperature is between 4 and 30° C.; and the reaction time period is between one and four hours.

4. The method as claimed in claim 1, wherein the concentration of the ammonia water (ammonium hydroxide) is from 10 to 25%; the filling speed of the ammonia water is from 1 to 30 ml/min depending on pH value of the solution; in the neutralization process, an agitation operation is executed, and the agitation speed is between 120 to 1200 rpm with a reaction time between one to four hours; and the addition of ammonia water is ended at the pH value being equal to 5 to 9.

5. The method as claimed in claim 1, wherein in the cleaning process, the titanium hydroxide (or titanic acid) precipitated in solution is filtered out and then cleaned; and a dewaterer, a compressing filter, a vacuum filter or a centrifuge is used in as the filter in the filter operation; filtered cake is disposed in running water for agitation and thus it can be used in filtering again, and the volume amount of running water is 3 to 20 times of the filter cake; agitation speed is between 120 to 1200 rpm through 10 to 120 minutes; and the cleaning process is repeated through four to five times.

6. The method as claimed in claim 1, wherein the filter cake is placed in de-ionized water to be agitated and thus to be mixed uniformly; and then selected oxidant or inorganic acid is added for performing a form-transfer process; the oxidant is selected from at least one of perchloric acid, periodide acid, potassium permanganate, sodium permanganate, and nitric acid; and 1 to 200 grams/liters oxidant is used; the inorganic acid is selected from at least one of perchloric acid, periodide acid, nitric acid, phosphoric acid, hydrochloric acid, sulfuric acid, and hydrogen iodide, hydrobromic acid; 1 to 200 grams/liters inorganic acid is added; the form-transfer temperature is between 10 to 95° C. and the agitation speed in form transfer is between 30 to 300 rpm and time period for agitation is between 10 and 120 minutes.

7. The method as claimed in claim 1, wherein the formation process is executed in an original tank or is executed in another tank with an agitation speed between 30 and 300 rpm, and temperature is between 50 and 95° C., and time period is between 4 and 24 hours.

8. The method as claimed in claim 1, wherein the product is packaged depending on applications and necessity.
